(19) United States
(12) Patent Application Publication
(10) Pub. No.: US 2021/0009303 A1
(43) Pub. Date: Jan. 14, 2021

(54) Child-Resistant Cap and a Combination of Child-Resistant Cap and Prescription Pill Bottle

(71) Applicant: Sun Hyun Kim, Toronto (CA)

(72) Inventor: Sun Hyun Kim, Toronto (CA)

(21) Appl. No.: 16/525,365

(22) Filed: Jul. 29, 2019

Related U.S. Application Data
(62) Division of application No. 16/510,856, filed on Jul. 12, 2019.

(51) Int. Cl. B65D 1/02; B65D 50/00; A61J 1/03

(52) U.S. Cl. CPC B65D 1/023; B65D 2501/0081; A61J 1/03; B65D 50/00

(57) ABSTRACT

The present invention relates to child-resistant cap and prescription pill bottle for dispensing prescription medications, such as tablets and capsules. The present inventions of push-down-and-turn child-resistant caps relate to two novel closure mechanisms and one improved mechanism using tapered detent in the camming latch that lead to the locking notch for smoother operation, as well as cap with ergonomic grip. All three mechanisms offer easier operation with a simple resilient disc member. The present invention of prescription pill bottle is a plurality of elliptical cylindrical shaped bottle which offers ergonomic grip compare to the circular cylindrical shape currently used. In addition, the bottles offer a relatively planar surfaces for prescription and auxiliary labels, which eliminate the action of rotating the bottle back-and-forth to read the labels.

### CROSS REFERENCE

| Publication | Priority | Publication | | |
|---|---|---|---|---|
| number | date | date | Assignee | Title |
| US327225A | | 1885 Sep. 29 | | Stand or casing |
| | | | | for bottles |
| US942141A | 1909 Jan. 5 | 1909 Dec. 7 | American | Jar and bottle |
| | | | Stopper Company | closure. |
| US1435723A | 1919 Aug. 28 | 1922 Nov. 14 | Edward J Mayer | Carboy hood |
| US3072276A | 1960 Apr. 21 | 1963 Jan. 8 | Celluplastics | Spring member for |
| | | | Inc | tamper proof vial |
| US2987207 | 1960 Oct. 3 | 1961 Jun. 6 | Stevoff George | Safety container |
| | | | | and locking cap |
| | | | | therefor |
| US3155259A | 1963 Dec. 26 | 1963 Dec. 26 | Scheurman Abbie | Safety medicine |
| | | | | bottle and cap |
| US3344942A | 1966 Apr. 5 | 1967 Oct. 3 | Hedgewick Peter | Safety cap and |
| | | | | container |
| US340795A | 1966 Aug. 18 | 1968 Oct. 29 | Millis Alexander | Container and |
| | | | | closure therefor |
| US3435975A | 1967 Oct. 30 | 1969 Apr. 1 | Tamper Proof | Safety closure |
| | | | Tops Ind Ltd | |
| US3880313A | 1968 Mar. 4 | 1975 Apr. 29 | Edward G Akers | Safety cap and |
| | | | | container |
| US3557985A | 1969 Jun. 2 | 1971 Jan. 26 | Marcel Louis | Tamper-proof |
| | | | St Denis | plastic closure |
| | | | | cap and method |
| | | | | of making same |
| US3450290A | | 1969 Jun. 17 | Lloyd S Turner | Safety closure |
| | | | | for a container |
| US3608764A | 1969 Sep. 5 | 1971 Sep. 28 | Reflex Corp | Safety closure |
| | | | Canada Ltd | assembly |
| US3612324A | 1969 Sep. 25 | 1971 Oct. 12 | Dell M Malick | Safety cap and |
| | | | | container neck |
| | | | | construction |
| US3613928A | 1970 Dec. 28 | 1971 Oct. 19 | Eyelet | Safety-closure |
| | | | Specialty Co | device |
| US3703974A | 1971 Mar. 8 | 1972 Nov. 28 | Leo M Boxer | Safety cap |
| US3716161A | | 1973 Feb. 13 | R Julian | Safety closure |
| | | | P Gach | for a medicine |
| | | | | bottle or the like |
| US3809276A | 1972 Sep. 27 | 1974 May 7 | Eyelet | Plastic bottle and |
| | | | Specialty Co | cap construction |
| US3880313A | 1968 Mar. 4 | 1975 Apr. 29 | Edward G | Safety cap and |
| | | | Akers | container |
| US3880314A | 1973 Apr. 16 | 975-04-29 | Edward G | Container and |
| | | | Akers | safety cap |
| US3951289A | 1971 Mar. 22 | 1976 Apr. 20 | Eyelet | Safety-closure |
| | | | Specialty | device |
| | | | Co., Inc. | |
| CA949496A | 1971 Jul. 26 | 1974 Jun. 18 | Anchor Cap | Safety closure |
| | | | And Closure | and package |
| | | | Corporation | |
| | | | Of Canada | |
| DE2533230A1 | 1975 Jul. 25 | 1977 Feb. 10 | Finke | Child proof |
| | | | Kunststoff | screw- on bottle |
| | | | Robert | top has two |
| | | | | external lugs |
| | | | | with radially |
| | | | | inclined teeth |
| | | | | 9nl270177) |
| FR2471329A1 | 1979 Dec. 17 | 1981 Jun. 19 | Barbarroux | Child-resistant |
| | | | Louis | screw cap closure - |
| | | | | with external levers |
| | | | | which must be |
| | | | | operated while |
| | | | | unscrewing the |
| | | | | closure |
| US4053078A | 1976 Aug. 18 | 1977 Oct. 11 | Kerr Glass | Child safety |
| | | | Manufacturing | closure |
| | | | Corporation | |
| US4059198A | 1977 Jan. 26 | 1977 Nov. 22 | Owens-Illinois, | Vapor-seal safety |
| | | | Inc. | cap and container |
| US4134513A | | 1979 Jan. 16 | | Child-resistant |
| | | | | safety closure |
| US4279355A | 1980 Apr. 11 | 1981 Jul. 21 | Rite | Twist-lock |
| | | | Autotronics | container |
| | | | Corporation | |
| US4310105A | 1980 Apr. 24 | 1982 Jan. 12 | Rexam | Child-resistant |
| | | | Plastics Inc | dispensing closure |
| US4337869A | 1981 Jan. 19 | 1982 Jul. 6 | Owens-Illinois, | Closure assembly |
| | | | Inc. | |
| US4383619 | 1981 May 14 | 1983 May 17 | Owens-Illinois, | Convertible |
| | | | Inc. | child-resistant |
| | | | | closure assembly |
| US4387821A | 1979 Dec. 20 | 1983 Jun. 14 | A.M.S. | Stopping device |
| | | | (Ateliers De | for bottle |
| | | | Moulage | |
| | | | Specialise) | |
| US4452364A | 1983 Feb. 7 | 1984 Jun. 5 | Kay Ronald D | Safety closure |
| | | | | device for |
| | | | | medicine container |
| US4526281A | 1984 Aug. 9 | 1985 Jul. 2 | Kerr Glass | Moisture tight |
| | | | Manufacturing | closure and |
| | | | Corporation | container |
| US4579238A | 1985 Apr. 23 | 1986 Apr. 1 | Kerr Glass | One-piece |
| | | | Manufacturing | moisture-tight |
| | | | Corporation | safety closure |
| | | | | and container |
| US4749093A | 1985 Jul. 22 | 1988 Jun. 7 | O. Lee Trick | Child-resistant |
| | | | | medication reminder |
| EP0289111B1 | 1991 Jan. 23 | | | Child resistant |
| | | | | dispensing closure |
| ES1007964Y | 1988 Oct. 20 | 1991 Apr. 16 | Henkel | Tapon perfected |
| | | | Iberica, S.A. | security. |
| DE9004546U1 | 1990 Apr. 21 | 1990 Jun. 28 | Messer | |
| | | | Griesheim | |
| | | | Gmbh, 6000 | |
| | | | Frankfurt, De | |
| US5320233A | 1994 Jun. 14 | | | Tamper evident |
| | | | | lug cap |
| US5411161A | 1994 Aug. 19 | 1995 May 2 | Fish, Jr.; | Container having a |
| | | | Milton L. | twist-locking cover |
| US5449078A | 1994 Jul. 8 | 1995 Sep. 12 | Thermar | Combination of a |
| | | | Corporation | container and a |
| | | | | safety cap therefore |
| US5819968A | 1997 Mar. 6 | 1998 Oct. 13 | Jones; William | Senior friendly |
| | | | Thomas | child resistant |
| | | | | medication containers |
| US5927532A | 1997 Apr. 21 | 1999 Jul. 27 | Owens- Illinois | Vapor-seal child |
| | | | Closure Inc. | resistant closure |
| | | | | and container package |
| US6082565A | 1999 Aug. 26 | 2000 Jul. 4 | Valley Design | Child resistant |
| | | | Inc. | cap with one-way |
| | | | | ratchet and |
| | | | | locking channel |
| USD485185S1 | 2001 Jun. 29 | 2004 Jan. 13 | Gianni | Cosmetics bottle |
| | | | Versace SpA | |
| US6378713B2 | | 2002 Apr. 30 | | Safety closure |
| | | | | and container |
| US6446823B2 | 2000 Feb. 29 | 2002 Sep. 10 | Tri State | Reversible child |
| | | | Distribution, Inc. | resistant cap and |
| | | | | combination of a |
| | | | | container and a |
| | | | | reversible child |
| | | | | resistant cap |
| US7070063B2 | 2000 Feb. 29 | 2006 Jul. 4 | Tri State | Reversible child |
| | | | Distribution Inc | resistant cap and |
| | | | | combination of a |
| | | | | container and a |
| | | | | reversible child |
| | | | | resistar cap |
| US20060289377A1 | 2000 Feb. 29 | 2006 Dec. 28 | Tri State | Reversible Child |
| | | | Distribution, Inc | Resistant Cap and |
| | | | | Combination of a |
| | | | | Container and a |
| | | | | Reversible Child |
| | | | | Resistant Cap |
| AU2003239615A1 | 2002 May 24 | 2003 Dec. 12 | Comar, Inc. | Helical lock |
| | | | | closure system |
| US7021477B2 | 2003 Mar. 3 | 2006 Apr. 4 | Owens-Illinois | Child-resistant |
| | | | Prescription | closure and |
| | | | Products, Inc. | container package |
| GB2399814B | 2003 Mar. 26 | 2007 May 9 | Portola | Closures and |
| | | | Packaging Ltd | containers in |
| | | | | combination therewith |
| USD511461S1 | 2003 Dec. 9 | 2005 Nov. 15 | SGD SA | Bottle |
| US20050230341A1 | 2004 Apr. 14 | | | |
| US20050263477A1 | 2003 Oct. 13 | 2005 Dec. 1 | Konefal | Closure and |
| | | | Robert S | container |
| | | | | package with |
| | | | | child-resistant |
| | | | | and non-child- |
| | | | | resistant modes |
| | | | | of operation |
| US7331479B2 | 2004 Apr. 29 | 2008 Feb. 19 | Rexam Delta | Child resistant |
| | | | Inc. | container and cap |
| US7819264B2 | 2003 Dec. 3 | 2010 Oct. 26 | Rexam Closure | Child-resistant |
| | | | Systems Inc. | closure, container |
| | | | | and package |
| US7165692B2 | 2004 Jan. 30 | 2007 Jan. 23 | Owens-Illinois | Child-resistant |
| | | | Prescription | closure and |
| | | | Products Inc. | container package |
| US7185776B1 | 2004 Feb. 16 | 2007 Mar. 6 | Owens-Illinois | Closure and |
| | | | Prescription | container package |
| | | | Products Inc. | |
| US7387214B1 | 2004 Sep. 27 | 200-06-17 | Rexam | Closure and |
| | | | Prescription | container package |
| | | | Products Inc. | with child- |
| | | | | resistant and non- |
| | | | | child-resistant |
| | | | | modes of operation |
| US7401706B2 | 2004 Sep. 27 | 2008 Jul. 22 | Rexam | Closure and |
| | | | Prescription | package having |
| | | | Products Inc. | child-resistant |
| | | | | and non-child- |
| | | | | resistant modes |
| | | | | of operation |
| US7427373B1 | 2004 Sep. 1 | 2008 Sep. 23 | Pacific | Method and apparatus |
| | | | Management | for forming a closure |
| | | | Holding, Llc | device and a container |
| US7510094B1 | 2005-01-94 | 2009 Mar. 31 | Rexam | Child resistant one |
| | | | Closures And | piece push and turn |
| | | | Containers Inc. | closure |
| US7527159B2 | 2004 Mar. 11 | 2009 May 5 | Rexam Closure | Threaded child- |
| | | | Systems inc. | resistant package |
| | | | | having linerless |
| | | | | closur |
| EP1776288A2 | 2004 Jun. 18 | 2007 Apr. 25 | Silgan White | Composite closure with |
| | | | Cap Americas LLC | barrier end panel |
| US7703617B1 | 2004 Nov. 19 | 2010 Apr. 27 | Rexam | Bayonet closure |
| | | | Closures And | container combination |
| | | | Containers, Inc. | with angled bayonet |
| | | | | lugs |
| USD550564S1 | 2005 Mar. 4 | 2007 Sep. 11 | Partida | Bottle |
| | | | Tequila LLC | |
| US7922017B2 | 2005 May 12 | 2011 Apr. 12 | Rexam | Child-resistant |
| | | | Prescription | closure, container and |
| | | | Products Inc. | package convertible |
| | | | | to non-child |
| | | | | resistant operation |
| US8132684B2 | 2005 Jul. 14 | 2012 Mar. 13 | Rexam | Child-resistant |
| | | | Prescription | closure, package |
| | | | Products Inc. | and method of making |
| US20060273060A1 | 2005 Jun. 6 | 2006 Dec. 7 | Mark Fricke | Reversible vial |
| | | | | closure |
| US20070034589A1 | 2005 Aug. 2 | 2007 Feb. 15 | Robert Zeide | Convertible child- |
| | | | | resistant cap |
| US20110056948A1 | 2009 Sep. 4 | 2011 Mar. 10 | Pacific | Pharmaceutical |
| | | | Management | Container Having |
| | | | Holding, Llc | Non-Child- |
| | | | | Resistant Closure |
| US9527619B2 | 2009 Oct. 21 | 2016 Dec. 27 | Innovative | Biodegradable |
| | | | Bottles, Inc. | pharmacy container |
| | | | | and safety cap |
| USD696957S1 | 2011 Jul. 29 | 2014 Jan. 7 | Stella | Bottle |
| | | | McCartney Ltd | |
| US8881988B2 | 2012 May 22 | 2014 Nov. 11 | Tri State | Method of |
| | | | Distribution, Inc. | providing custom |
| | | | | information to |
| | | | | users of |
| | | | | pharmaceutical |
| | | | | storage systems |
| US8662331B2 | 2012 May 22 | 2014 Mar. 4 | Tri State | One piece |
| | | | Distribution, Inc. | reversible |
| | | | | closure and |
| | | | | container system |
| US9487335B2 | 2012 May 22 | 2016 Nov. 8 | Tri State | One piece |
| | | | Distribution, Inc. | reversible |
| | | | | closures with |
| | | | | custom removable |
| | | | | liners |
| USD691894S1 | 2012 Aug. 31 | 2013 Oct. 22 | Spirit Works | Bottle |
| | | | Distillery LLC | |
| USD714654S1 | 2013 Apr. 19 | 2014 Oct. 7 | Valentino SpA | Container for |
| | | | | perfumes |
| EP3083433A4 | 2013 Dec. 19 | 2017 Aug. 9 | Berry Plastics | Closure for |
| | | | Corporation | container |
| CN104875946A | 2014 Feb. 28 | 2015 Sep. 2 | | Medicine bottle |
| | | | | with child |
| | | | | protective device |
| JP6359391B2 | 2014 Sep. 12 | 2018 Jul. 18 | | Fluid container |
| USD799976S1 | 2016 Apr. 11 | 2017 Oct. 17 | Bottega | Perfume bottle |
| | | | Veneta SA | |

### STATEMENT OF FEDERALLY SPONSORED RESEARCH OR DEVELOPMENT

Not Applicable

### BACKGROUND OF THE INVENTION

Child-resistant caps are used to prevent young children from accessing the contents of a bottle or a container and consuming them inadvertently. The general objective of the child-resistant closure mechanism is the use of multiple steps to remove the cap from the bottle or the container which would not be obvious to and difficult for young children intuitively figure out. One of the challenges with child-resistant caps is that elderly and frail people may also encounter difficulty in removing the child-resistant cap from the bottle or the container due to a number of factors, including weakness and reduced manual dexterity due to musculoskeletal diseases, such as arthritis.

One of the commonly used child-resistant closure mechanisms is the push-down-and-turn the cap to remove the cap from the container system. The current design of the detent on the locking notch with the closure system is angular resulting in “stickiness” when the lug from the cap is disengaged from the locking notch on the container system, which can cause difficulty and even pain in the process for some people. The present invention relates to two new and one improved child-resistant closure mechanism using tapered detent on the locking notch to reduce the “stickiness” when removing the cap from the container system.

In addition, the present invention relates to new and improved prescription pill bottles and caps. Currently, prescription medications, such as tablets and capsules, are dispensed by pharmacies in circular, cylindrically-shaped prescription medication vials, with the prescription and auxiliary labels affixed wrapped around the barrel of the vial and some of the caps used are also circular cylindrical in shape and have a narrow grip area. There are a number of disadvantages with these vials and caps, which the present invention aims to address.

The first disadvantage of the vials are that they are not ergonomic. In order to grip the vials, there is a considerable bending of the fingers. This action can be difficult and even painful for people with reduced manual dexterity due to musculoskeletal diseases, such as arthritis. Secondly, in order to read the instructions on the labels affixed on them, one has to rotate the vials back-and-forth, which is not ideal for reading the instructions on the labels especially if the instruction in not straightforward. As for the caps, Some of the caps have a combination of a narrow grip area and knurling, which can make removing the cap difficult and even painful, again especially for those with reduced manual dexterity, such as arthritis.

The aging population is increasing and generally, the incidences of musculoskeletal diseases increase with age, as well as other medical conditions, such as high blood pressure, diabetes, high cholesterol, etc. As a result, the number of people requiring prescription medications, as well as the number of medications taken by each person will increase with time. For a number of people, the use of prescription medications already are an integral part of their lives and will become for many more with time. Therefore, it is important to have pharmacy pill bottles and child-resistant caps that are ergonomic and easy to use, and bottles that offer a relatively easy reading platform for the labels. The present invention aims to have a positive impact on the lives of many people who have to take prescription medications daily by offering ergonomic bottles and caps, and ergonomic bottles with a relatively planar surfaces for labels.

### BRIEF SUMMARY OF THE INVENTION

Embodiments of the present invention is a novel child-resistant closure mechanism comprising of a plurality of J-shaped grooves located circumferentially spaced around the outward side of the neck of the bottle or a container system where the longer vertical groove opens at the rim of the neck. To cover the mouth opening of the bottle or a container system with a cap, the grooves engage with the locking lugs located circumferentially spaced on the inner surface of the cap projecting inwardly spaced and configured to fit the grooves. Once the lugs engage with the grooves that open at the rim of the neck, the cap is pushed axially along the longer grooves. When the lugs reach the curving part of the J-grooves, the cap is rotated clockwise which causes the lugs to glide along the curvature of the J-grooves. After the lugs pass the curvature of the J-shaped groove, the resilient member located inside the top part of the cap causes the lugs to push up into the short vertical grooves where the lugs rest in a locked position. The cap is now in a locked position. The cap is removed from the neck by pressing the cap axially against the neck which releases the lugs from the shorter vertical grooves, then by turning the cap counter clockwise causing the lugs to glide along the curved grooves, and then by pulling the cap axially along the longer vertical grooves and then off the neck. The grooves, in the shape of the capital letter J, on the neck offer a novel child-resistant closure mechanism and are easy to use.

Another embodiments of the present invention is a plurality of a variation of the J-shaped groove located circumferentially spaced around the outward side of the neck where the opening of the groove at the rim of the neck is wide to allow easier engagement of the locking lug on the cap with the groove on the neck. The wide groove entrance funnels into a narrower, vertical groove guiding the lug into a locking position thereafter in the same manner as with aforementioned J-shaped groove.

Another embodiments of the present invention is an improvement in the design of the existing push-down-and-turn child-resistant closure mechanism comprising tapered camming latch leading to an angular detent that is part of the notch on the neck of the bottle or a container system which receives the locking lug from the cap to close the mouth opening on the bottle or a container system. The detent causes stiff, “sticky” release of the locking lug when the lug is disengaged from the notch. The stiffness can make the cap difficult to remove and even be painful for people with musculoskeletal disorder, such as arthritis. The stiffness can be reduced by tapering the detent. The present invention relates to a camming latch leading to a tapered detent part of the notch for smoother transition of the lug. It is understood the neck may have a plurality of camming latch with a tapered detent/notch.

Another embodiments of the present invention is a cap that is comprised of a top panel and an annular skirt, which depends downwardly from the outward periphery of the top panel forming the cap body. A resilient member is fitted inside the upper end of the cap body. On the inner surface of the cap body is a plurality of locking lugs projecting inwardly. The lugs engage with the grooves on the neck of the bottle or the container system in one closure mechanism and with the camming latches and are received into the locking notches on the neck of the bottle or the container system in another closure mechanism to close the mouth opening of the bottle or the container system. The resilient member located inside the upper end of the cap body permits the cap to be pressed axially against the neck and release the lugs from the locked position and allow the cap to be removed from the neck. The cap body may have the upper end wider than the lower end, thus having the appearance of an upside down, truncated circular cone and offers a relatively wide grip area. Alternatively, the cap body may have the traditional circular cylindrical shape.

Another embodiments of the present invention are a plurality of generally elliptical cylindrically-shaped pharmacy pill bottle. The front and the back of the bottle are slightly curved, which are connected by curved side portions forming the generally elliptically shaped bottle. At the top-center of the bottle is a wide, circular cylindrically-shaped neck connected via the shoulder and at the upper end of the neck is a mouth that opens into the chamber of the bottle.

The intended use of the present invention is for dispensing prescription medications, such as tablets and capsules, by pharmacies. The present invention of child-resistant cap may be applied to a bottle and other container system. The present invention of child-resistant cap is easier to operate than the comparable push-down-and-turn caps. The present invention of prescription pill bottle offers ergonomic grip compared to the traditional prescription pill vial thereby reducing hand-fatigue and thus improving the quality of life of those who have to use the prescription pill vials daily. In addition, the present invention of prescription pill bottle offers a relatively planar surfaces on the front and the back for prescription and auxiliary labels to be affixed allowing following the instructions on the labels easier.

### BRIEF DESCRIPTIONS OF THE SEVERAL VIEWS OF THE DRAWING

In drawings, embodiments of the present invention is described as follows:

FIG. 1 is a perspective view of a plurality of generally elliptical cylindrically-shaped prescription pill bottle, one with the upside down, truncated, cylindrical cone shaped cap on and another with the traditional circular cylindrical cap on, according to an embodiment of the invention;

FIG. 2 is a front view thereof of the bottle with caps separate illustrating the J-shaped groove on one side of the bottle with the opening of the groove at the rim of the neck, according to an embodiment of the invention;

FIG. 3 is a front view thereof of the bottle without cap on illustrating the wide opening of the groove at the rim of the neck on one side of the bottle, according to an embodiment of the invention;

FIG. 4 is a front view of the bottle without cap on illustrating the camming latch with tapered detent on the locking notch on the lower end of the neck on one side of the bottle, according to an embodiment of the invention;

FIG. 5 is a side view thereof of a plurality of the bottle with cap on, according to an embodiment of the invention;

FIG. 6 is a top view thereof of the neck of the bottle illustrating the top view of the J-shaped grooves that open at the rim of the neck and located diametrically opposite of each other, according to an embodiment of the invention;

FIG. 7 is a top view thereof of the neck of the bottle illustrating the top view of the wide opening of the grooves that open at the rim of the neck and located diametrically opposite of each other, according to an embodiment of the invention;

FIG. 8 is a top view thereof of the neck of the bottle illustrating the top view of the camming latch leading to the detent and the locking notch on the neck, according to an embodiment of the invention;

FIG. 9 is a perspective view thereof of the neck of the bottle illustrating the J-shaped groove on one side of the neck, according to an embodiment of the invention;

FIG. 10 is a perspective view thereof of the neck of the bottle illustrating the wide opening of the groove, a variant of the J-shaped groove, on one side of the neck, according to an embodiment of the invention;

FIG. 11 a perspective view thereof of the neck of the bottle illustrating the camming latch leading to the tapered detent and the locking notch on one side of the neck, according to an embodiment of the invention;

FIG. 12 is a perspective view thereof of a cap illustrating one of the lugs on the inner surface of the annular skirt and a resilient member, according to an embodiment of the invention;

FIG. 13 is a bottom view thereof of the cap illustrating the two lugs located diametrically opposite side of each other and a resilient member, according to an embodiment of the invention; and

FIG. 14 is an exploded view of a cap, a resilient member and one of the bottles, according to an embodiment of the invention.

### DETAILED DESCRIPTION OF THE INVENTION

Embodiments of the present invention pertain to a plurality of prescription pill bottles that are generally elliptical cylindrically-shaped in body. The shape conforms to the contour of the hand at relaxed state. As a result, there is less bending of the finger, hand, and forearm muscles when gripping the bottles, thereby reducing strain on the said muscles and hand-fatigue. The bottle has a relatively planar surfaces on the front and the back portions for the prescription and auxiliary labels, which will allow easier reading of the labels and eliminate the need to rotate the bottle back-and-forth to read them. The bottle has a relatively wide and circular cylindrically-shaped neck and a mouth for dispensing tablets, capsules and such. The new bottles do not require any changes to the existing labelling system used by pharmacies, which will make the transition from the traditional vials efficient.

In drawings, the following figures illustrate embodiments of the present invention:

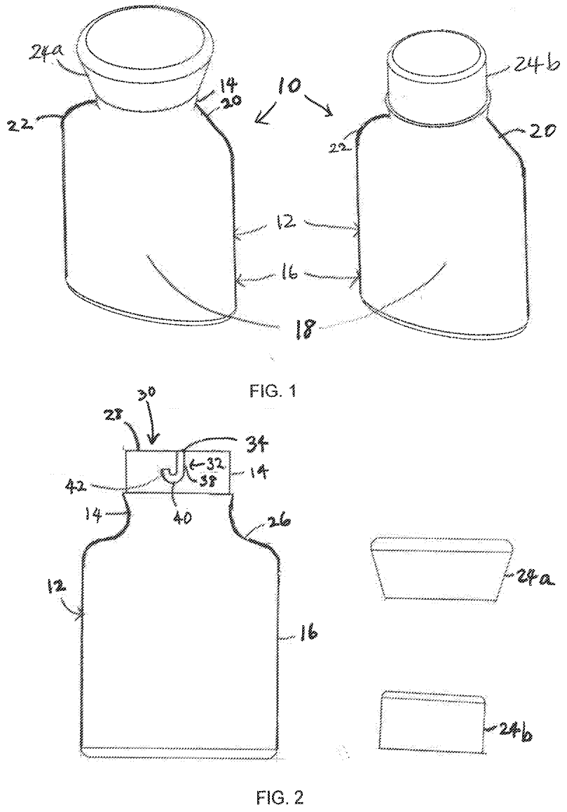

In FIG. 1, in one embodiment, pharmacy bottle system 10 illustrates a perspective view of a plurality of prescription pill bottle 12 that is generally elliptical cylindrical in shape with a wide, circular cylindrical neck 14, for dispensing tablets, capsules, and such. Bottle 12 comprises a container 16, which comprises a front portion 18 that is slightly curved, but relatively planar and a back portion 20 that is slightly curved, but relatively planar—where prescription and auxiliary labels are affixed—connected by a side portion 22 that is curved to form a generally elliptical, cylindrical shape. The cap 24a is generally shaped of a truncated, upside down cone. Alternatively, it is shaped circular cylindrical similar to the traditional cap 24b.

FIG. 2 is a front view thereof of the prescription pill bottle 12, according to an embodiment of the invention. Bottle 12 comprises a container 16, which comprises shoulders 26, and a circular cylindrical neck 14 in the center of the shoulders 26. A circular mouth 28 is located at the upper end of the neck 14. The mouth 28 opens 30 to inside of the container 16. On the outward side of the neck 14, circumferentially spaced is a plurality of grooves 32 in the shape of the capital letter J that open 34 at the rim of the neck 14 configured and spaced to engage with locking lugs 36 located on the inner side of the cap 24a/b projecting inwardly. To cover the opening 30 in the mouth 28, the lugs 36 engage with the grooves 32 at the opening 34 at the rim of the neck 14. The cap is then pushed axially along the long vertical grooves 38 until the lugs reach the curvature of the grooves 40. The cap is then rotated clockwise until the lugs 36 reach the short grooves 42 and rest in the short grooves 42. The cap 24a/b is now in a locked position.

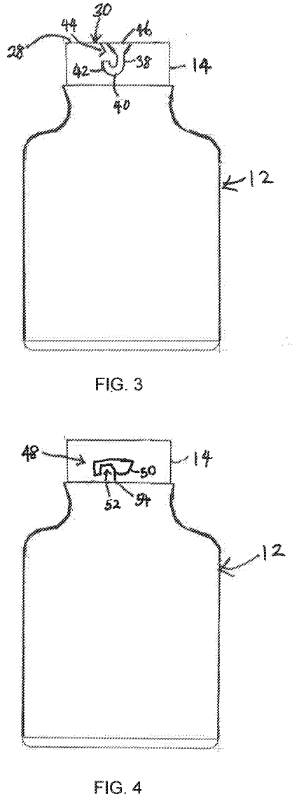

FIG. 3 is a front view thereof of the prescription pill bottle 12, according to an embodiment of the invention. On the outward side of the neck 14 of the bottle 12 is a plurality of circumferentially spaced grooves 44 that are a variation of the J-shaped grooves 32 in that the opening 46 of the grooves 44 at the rim of the neck 14 is wide for easier alignment of the grooves 44 with the locking lugs 36 from the cap 24a/b to cover the opening 30 in the mouth 28. Thereafter, the cap 24a/b is pushed axially along the longer vertical grooves 38, then turned clockwise when the lugs reach the bottom of the grooves 40 causing the lugs to slide along the curvature of the grooves 40 and then released into the locking position in the short vertical grooves 42.

FIG. 4 is a front view thereof of the prescription pill bottle 12, according to an embodiment of the invention. On the outward side of the neck 14 is a plurality of circumferentially spaced, radially extending projections 48 comprising of tapered cam 50 that lead to locking notch 52 with tapered detent 54 therein, sized and configured to receive locking lugs 36 from the cap 24a/b. The tapered detents 54 allow smoother disengagement of the lugs 36 when the cap 24a/b is removed from the neck 14.

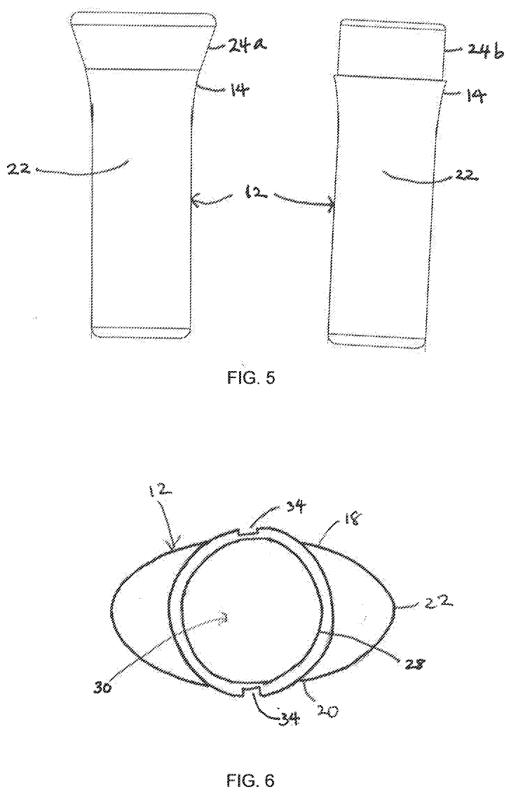

FIG. 5 is a side view thereof of a plurality of prescription pill bottle 12 illustrating a wide neck 14 and side portion 22 of the bottle 12 with cap on 24a/b, according to an embodiment of the invention.

FIG. 6 is a top view thereof of the prescription pill bottle 12, according to an embodiment of the invention, illustrating mouth 28 and opening 30, encompassing the front 18 and the back portion 20 of the container 12. The curved side portions 22 connect the slightly curved, but relatively planar front portion 18 to the slightly curved, but relatively planar back portion 20 forming a generally elliptical shape. The top view of the bottle 12 illustrates the opening 34 of the two J-shaped grooves 32 located diametrically from each other at the rim of the mouth. The grooves 32 are circumferentially spaced and engage with the lugs 36 from the cap 24a/b to form a child-resistant closure system. It is understood the neck may have a plurality of grooves 32 configured and spaced to receive a plurality of the lugs 36.

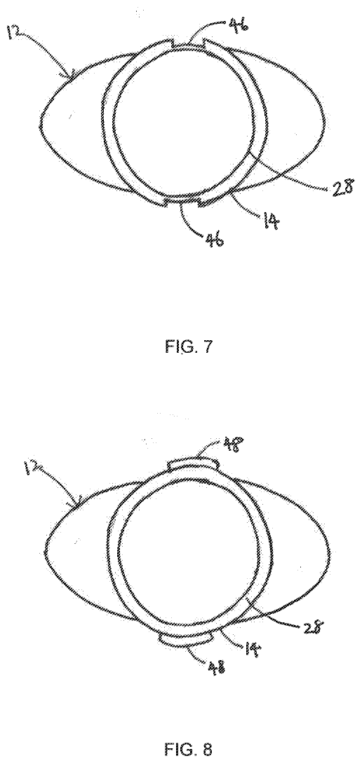

FIG. 7 is a top view thereof of the prescription pill bottle 12, according to an embodiment of the invention illustrating the top view of the mouth 28 with a circumferentially spaced grooves 44 with a wide opening 46 at the rim of the neck 14 for easier alignment with the lugs 36 from the cap 24a/b to engage and form a child-resistant closure system. It is understood the neck 14 may have a plurality of grooves 44.

FIG. 8 is a top view thereof of the prescription pill bottle 12, according to an embodiment of the invention illustrating the top view of the mouth 28 and of the two circumferentially spaced around the neck 14, radially extending projections 48 comprising of tapered cam 50 that lead to locking notch 52 with tapered detent 54 therein, sized and configured to receive locking lug 36 from the cap 24a/b. It is understood the neck may have a plurality of camming latches 50 with locking notches 52 sized and configured to engage with lugs 36 from the cap 24a/b.

FIG. 9 is a perspective view of the neck 14, according to an embodiment of the invention, illustrating the J-shaped groove 32 on the outer side of the neck 14 with the opening 34 at the rim of the neck 14 where the locking lug 36 engages, the long vertical groove 38 along which the cap is pushed axially and the curvature of the groove 40 where the cap 24a/b is rotated clockwise into the short vertical groove 42, the locked position. It is understood the neck may have a plurality of grooves 32 circumferentially spaced and configured to receive lugs 36 from the cap 24a/b.

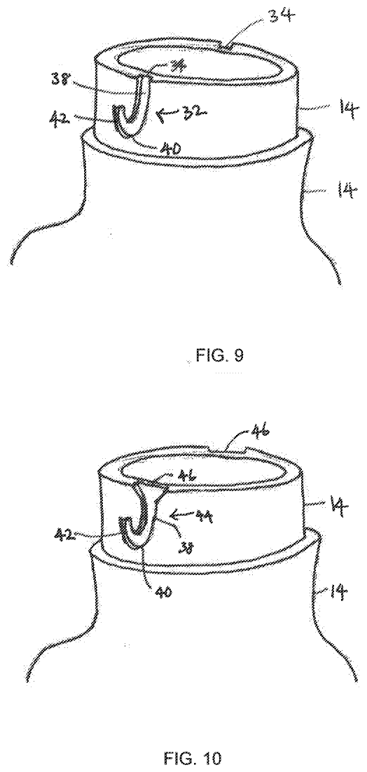

FIG. 10 is a perspective view thereof of the neck 14, according to an embodiment of the invention, illustrating a variant of the J-shaped groove 44 on the outer side of the neck 14 with a wide opening 46 at the rim of the neck 14 where the locking lug 36 engages with the groove 44, the longer vertical groove 38 along which the cap 24a/b is pushed axially and the curvature of the groove 40 where the cap 24a/b is rotated clockwise into the short vertical groove 42, the locked position. It is understood the neck may have a plurality of grooves 44 circumferentially spaced and configured to receive locking lugs 36 from the cap 24a/b.

FIG. 11 is a perspective view thereof of the neck 14, according to an embodiment of the invention, illustrating circumferentially spaced, radially extending projections 48 comprising of the tapered camming latches 50 that engage with the lug 36 and upon rotating the cap 24a/b clockwise leads the lug 36 into the locking notch 52 via the tapered detent 54. The tapered detent 54 on the notch 52 allows smooth disengagement of the lug 36 from the notch 52 when the cap 24a/b is rotated counter clockwise to remove the cap from the bottle. It is understood the neck 14 may have a plurality of projections 48 spaced and configured to receive a plurality of lugs 36 from the cap 24a/b.

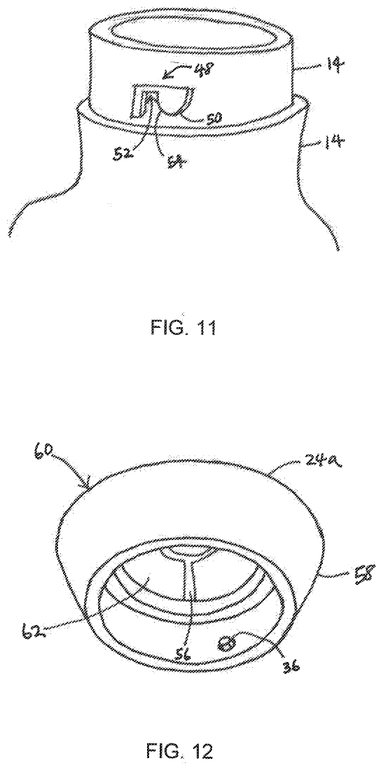

FIG. 12 is a perspective view of a cap 24a, according to an embodiment of the invention, illustrating the top panel 56 and an annular skirt 58 depending downward from the periphery of the top panel 56 forming the cap body 60. On the inner surface of the annular skirt 58 is a plurality of inward projections that form the locking lugs 36, which engage with the locking systems on the neck 14 on the bottle 12. In the upper end of the cap body 60 is a resilient member 62. The resilient member 62 allows the cap 24a to be pressed axially against the neck 14 to disengage the lugs 36 from the locking notches 52 or from the short vertical groove 42 prior to the removal of the cap 24a from the bottle 12. It is understood the cap 24a may have a plurality of lugs 36 spaced and configured to engage with the closure systems on the neck 14.

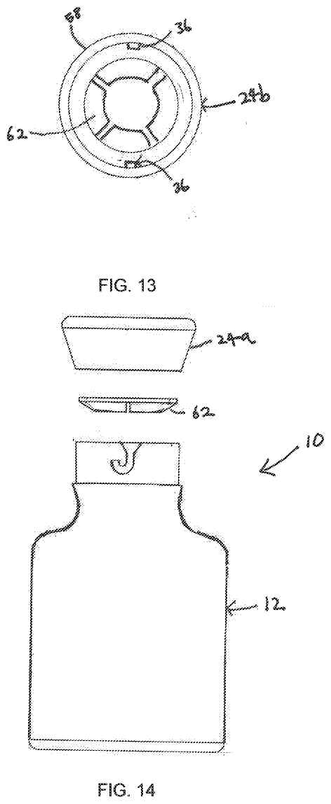

FIG. 13 is a bottom view thereof of a cap 24b, according to an embodiment of the invention, illustrating the two inward projecting lugs 36 located on the inner surface of the annular skirt 58 and a resilient member 62 in the upper end of the cap body. It is understood the cap 24b may have a plurality of lugs 36 spaced and configured to engage with the closure systems on the neck 14.

FIG. 14 is an exploded view of the pharmacy bottle system 10 illustrating a cap 24a, a resilient member 62 and a prescription pill bottle 12 with one of the three aforementioned child-resistant closure systems, according to an embodiment of the invention.

While specific embodiments have been illustrated and described herein, the scope of the present invention encompasses a plurality of prescription pill bottles that are generally elliptical cylindrical in shape, a plurality of cap that has a relatively wide grip area with the cap body shaped of an upside down, truncated cone and, alternatively, circular cylinder. The scope of the present invention also encompasses a child-resistant closure mechanism comprising of a plurality of circumferentially spaced grooves on the outward side of the neck of the bottle that engage with the locking lugs from the cap to provide bottle closure system. The scope of the present invention also encompasses a child-resistant closure mechanism comprising of circumferentially spaced, radially extending projections on the outward side of the neck comprised of tapered camming latch leading to tapered detent and the locking notch. The tapered detent results in a smoother disengagement of the lugs from the cap when the cap is removed from the bottle. The grooves and the outward projections on the neck are spaced and configured to receive the locking lugs on the cap. The shapes of the bottle and the cap are not new per se. However, their application to prescription pill bottle and cap is. The shape of the grooves on the neck is new and the detent on the locking notch is tapered, which is new. Both child-resistant mechanisms offer easier and smoother operation of child-resistant closure system than the existing push-down-and-turn closure mechanisms.

1. A pharmacy bottle comprising:
a container including:
a plurality of generally elliptical cylindrically-shaped body defining a chamber therein;

2. The pharmacy bottle of claim 1 wherein the container comprises an opening disposed at the top center of the body via shoulder and neck, which is adapted to removably receive a cap to cover the opening;

3. The pharmacy bottle of claim 2 wherein the neck is circular cylindrical in shape and has a plurality of grooves circumferentially spaced on the neck in the shape of the capital letter J to engage with locking lugs located on the inner surface of the cap and guide the locking lugs to slide along the grooves into a locking position to cover the opening on the bottle where the grooves are sized and configured to receive the locking lugs;

4. The pharmacy bottle of claim 3 wherein the neck is circular cylindrical in shape and has a plurality of grooves circumferentially spaced on the neck with a wide entrance to the groove at the rim of the neck for easier engagement with locking lugs located on the inner surface of the cap and funnel the locking lugs to slide along the grooves into a locking position to cover the opening on the bottle where the grooves are sized and configured to receive the locking lugs;

5. The pharmacy bottle of claim 2 wherein the neck is circular cylindrical in shape and has a plurality of circumferentially spaced, radially extending projections comprising tapered cam that leads to locking notches which has tapered detent where the projections are sized and configured to receive locking lugs on the cap to cover the opening on the bottle;

6. A plurality of cap with a relatively wide grip area comprised of top panel, an annular skirt forming the cap body and a resilient member, which is located in the top end of the cap body by the top panel;

7. The cap of claim 5 wherein there is a plurality of circumferentially spaced locking lugs on the inner surface of the annular skirt projecting inwardly, which are sized and configured to engage with the locking mechanisms on the neck of claims 3 and 4 to cover the opening on the bottle;

8. The cap of claim 6 wherein the cap body is in the shape of an upside down, truncated cone; and

9. The cap of claim 6 wherein, alternatively, the cap body is in the shape of a circular cylinder.
